(19) United States
(12) Patent Application Publication
(10) Pub. No.: US 2021/0302235 A1
(43) Pub. Date: Sep. 30, 2021

(54) System and Method for Contactless Temperature Screening

(71) Applicant: RPX Technologies, Inc., Stillwater, OK (US)

(72) Inventors: Michael Fox, Stillwater, OK (US); Matthew Dock, Stillwater, OK (US)

(21) Appl. No.: 17/215,974

(22) Filed: Mar. 29, 2021

Related U.S. Application Data
(60) Provisional application No. 63/001,068, filed on Mar. 27, 2020.

(51) Int. Cl. G01J 5/00; A61B 5/01; G01J 5/48

(52) U.S. Cl. CPC G01J 5/0025; A61B 5/01; G01J 2005/0048; G01J 2005/0077; G01J 5/48

(57) ABSTRACT

A method is disclosed. The method includes capturing, by an infrared camera, a first image of a first temperature controlled surface having a first known temperature below a temperature threshold, the infrared camera having an array of infrared sensors, the first image having first pixels, the first pixels having first data indicative of a plurality of first temperatures; capturing, by the infrared camera, a second image of a second temperature controlled surface having a second known temperature above the temperature threshold, the second image having second pixels, the second pixels having second data indicative of a plurality of second temperatures; and calibrating a plurality of the pixels in the array of infrared sensors with the first data and the second data.

### INCORPORATION BY REFERENCE

The present patent application claims priority to the provisional patent application identified by U.S. Ser. No. 63/001,068 filed on Mar. 27, 2020, the entire content of which is hereby incorporated by reference.

### BACKGROUND

Germs are a part of everyday life and are found in our air, soil, water, and in and on our bodies. Exemplary germs include a virus, bacteria, or other microbe. Some germs are helpful, others are harmful. Many germs live in and on our bodies without causing harm and some even help us to stay healthy. Only a small portion of germs are known to cause infection. An infection occurs when germs enter the body, increase in number, and cause a reaction of the body.

Three things are necessary for an infection to occur: a source, a susceptible person with a way for germs to enter the person's body, and transmission. A source is a place where infectious agents (germs) live (e.g., sinks, surfaces, human skin). Transmission refers to a way that germs are moved from the source to the susceptible person. A susceptible person is someone who is not vaccinated or otherwise immune, or a person with a weakened immune system who has a way for the germs to enter the body. For an infection to occur, germs must enter a susceptible person's body and invade tissues, multiply, and cause an immune system response.

People can be sick with symptoms of an infection or colonized with germs (not have symptoms of an infection but able to pass the germs to others). An indication that a person has an infection is an elevated body temperature, i.e., above normal body temperature. Normal body temperature is between 36.5 C and 37.5 C (97.7 F-99.5 F).

One way to prevent transmission of germs to a susceptible person is to reduce or prevent a person having an infection from interacting with the susceptible person. Transmission may occur anywhere that a person having an infection interacts with a susceptible person. Common places for transmission to occur are workplaces, healthcare facilities and social venues such as bars or restaurants.

Gatherings at events can create environmental and social conditions that facilitate the spread of germs by increasing crowding and contact rates, overextending sanitation and hygiene resources, and encouraging risky behaviors that enhance the transmission of germs.

There are currently many ways to determine whether or not a person has an infection, such as taking the person's temperature with a thermometer, and analyzing specimens from the person including blood, urine and saliva. All of these methods require contact with the person, such as the taking of a blood sample, or placing the thermometer in the person's mouth or ear. Although these methods are effective, such methods are not easily scalable to screen many people. Further, these methods generally require disposable items for testing each person.

To enhance the number of people that can be tested and reduce the cost of testing, there is a need for a screening methodology and device that can determine whether or not a person has an infection without requiring contact with the person, and without the use of any disposables. It is to such an improved screening methodology that the present disclosure is directed.

### BRIEF DESCRIPTION OF THE SEVERAL VIEWS OF THE DRAWING

These and other objects and features of the present invention will be more fully disclosed or rendered obvious by the following detailed description of the invention, which is to be considered together with the accompanying drawings wherein like numbers refer to like parts, and further wherein:

FIG. 1 is a diagrammatic view of an exemplary embodiment of a contactless sensing system having a remote sensing assembly capturing visible light and infrared light information of a person to be screened in accordance with the present disclosure.

FIG. 2A is a visible light image of an exterior surface of a person to be screened holding an identification device in accordance with the present disclosure.

FIG. 2B is a long-wavelength IR image of the exterior surface of the person to be screened holding the identification device in accordance with the present disclosure, the exterior surface of the person having a temperature detection region being indicative of the person's internal temperature.

FIG. 2C is a portion of the long-wavelength IR image of FIG. 2B, depicting the temperature detection region of the person to be screened, the portion of the long-wavelength IR image showing pixels having values indicative of surface temperatures of the temperature detection region.

FIG. 3 is a graph showing an influece of distance to a temperature measurement for a thermal imaging camera without taking into account correction of the impace of the atmosphere on the measurement (1) being longwavelength, 8-12 micron, and (2) being short wavelength, 2-5 micron.

FIG. 4 is a diagrammatic view of an exemplary embodiment of an infrared camera system having a filter to block wavelengths below 8 microns and pass wavelengths above 8 microns, and an environmental temperature calibration assembly in accordance with the present disclosure. The filter can be a bandpass, or a long-pass filter to pass wavelengths above 8 microns and block wavelengths below 8 microns.

FIG. 5 is a graph depicting an exemplary passband of a filter depicted in FIG. 4.

FIG. 6 is a block diagram of an exemplary infrared camera in accordance with the present disclosure.

FIG. 7 is a block diagram of an infrared sensor assembly including an array of infrared sensors in accordance with an embodiment of the present disclosure.

FIG. 8 is a block diagram of an exemplary computer system in accordance with an embodiment of the present disclosure.

### DETAILED DESCRIPTION

Before explaining at least one embodiment of the presently disclosed and claimed inventive concepts in detail, it is to be understood that the presently disclosed and claimed inventive concepts are not limited in their application to the details of construction, experiments, exemplary data, and/or the arrangement of the components set forth in the following description or illustrated in the drawings. The presently disclosed and claimed inventive concepts are capable of other embodiments or of being practiced or carried out in various ways. Also, it is to be understood that the phraseology and terminology employed herein is for purpose of description and should not be regarded as limiting.

In the following detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, certain well-known features may not be described in detail in order to avoid unnecessarily complicating the instant disclosure.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherently present therein.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

The use of ordinal number terminology (i.e., “first”, “second”, “third”, “fourth”, etc.) is solely for the purpose of differentiating between two or more items and, unless explicitly stated otherwise, is not meant to imply any sequence or order of importance to one item over another.

The term “and combinations thereof” as used herein refers to all permutations or combinations of the listed items preceding the term. For example, “A, B, C, and combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. A person of ordinary skill in the art will understand that typically there is no limit on the number of items or terms in any combination, unless otherwise apparent from the context.

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

The use of the terms “at least one” and “one or more” will be understood to include one as well as any quantity more than one, including but not limited to each of, 2, 3, 4, 5, 10, 15, 20, 30, 40, 50, 100, and all integers and fractions, if applicable, therebetween. The terms “at least one” and “one or more” may extend up to 100 or 1000 or more, depending on the term to which it is attached; in addition, the quantities of 100/1000 are not to be considered limiting, as higher limits may also produce satisfactory results.

Further, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein qualifiers such as “about,” “approximately,” and “substantially” are intended to signify that the item being qualified is not limited to the exact value specified, but includes some slight variations or deviations therefrom, caused by measuring error, manufacturing tolerances, stress exerted on various parts, wear and tear, and combinations thereof, for example.

Certain exemplary embodiments of the invention will now be described with reference to the drawings. In general, such embodiments relate to thermic infusion systems and methods.

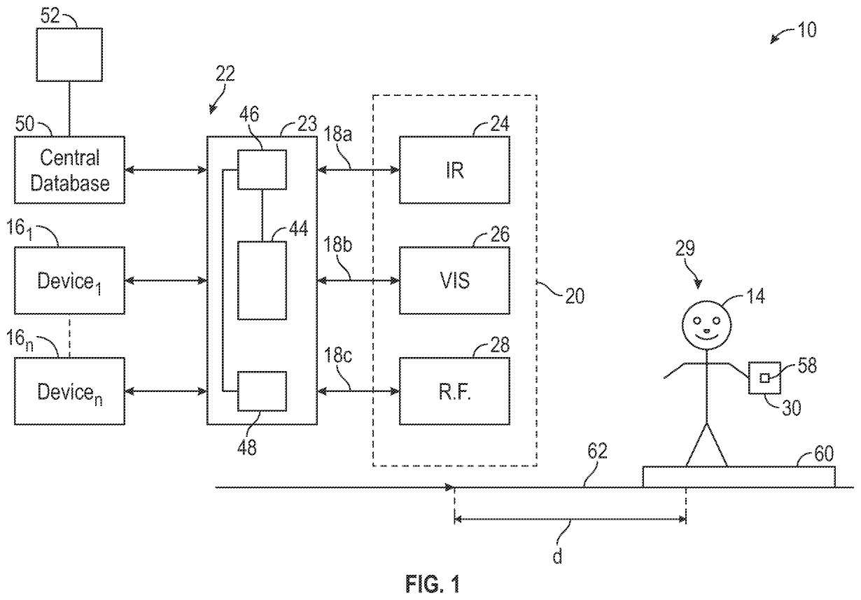

Referring to the Figures, and in particular to FIG. 1, illustrated therein is an exemplary contactless sensing system 10 in accordance with the present disclosure for screening one or more person 14 for the presence of an elevated internal temperature indicative of the presence of an infection. In one embodiment, the system 10 is provided with a plurality of devices 161-n with each device 161-n configured to perform an action, one or more communication links 18 configured to pass data from a sensor assembly 20 to a computer system 22. Three communication links are shown in FIG. 1 by way of example and labeled with the reference numerals 18a, 18b and 18c. The communication link(s) 18 may be conductive, optical, or wireless communication links. In some embodiments, the communication link(s) 18 may be a bus provided on one or more printed circuit board, for example connected with any suitable data connector(s).

Exemplary devices 16 include automated locks, or communication devices, such as a speaker, light emitter, or the like. The device 16 can be an automated lock on a door that performs an action, such as automatically unlocking a door based on a determination that the temperature of the person 14 is below a predetermined threshold of 98.6, for example, thereby allowing the person 14 entry into a predetermined space such as a gym, retail establishment, workspace, or the like. If the contactless sensing system 10 determines that the temperature of the person 14 is elevated, i.e., above the predetermined threshold thereby indicating an infection, then the device 16 may maintain the door in a locked condition and issue an alert notifying the person 14 that the person 14 may have an infection and need to take precautionary action, such as social distancing the person 14 from others, avoiding work or other activities, and/or providing secondary screening (using a more invasive test such as a thermometer) going to see a medical professional (doctor, physician's assistant or the like) to obtain a diagnosis and/or treatment.

The sensor assembly 20 may include a plurality of different types of sensors, such as an infrared camera 24, a visible light camera 26, and a range finder 28 all positioned to obtain information within a scene 29 include the person 14 and an identification device 30 associated with the person 14.

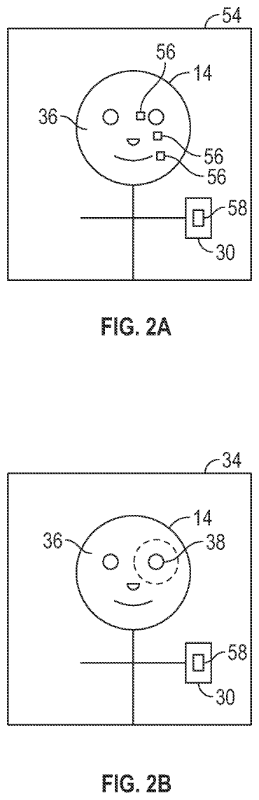

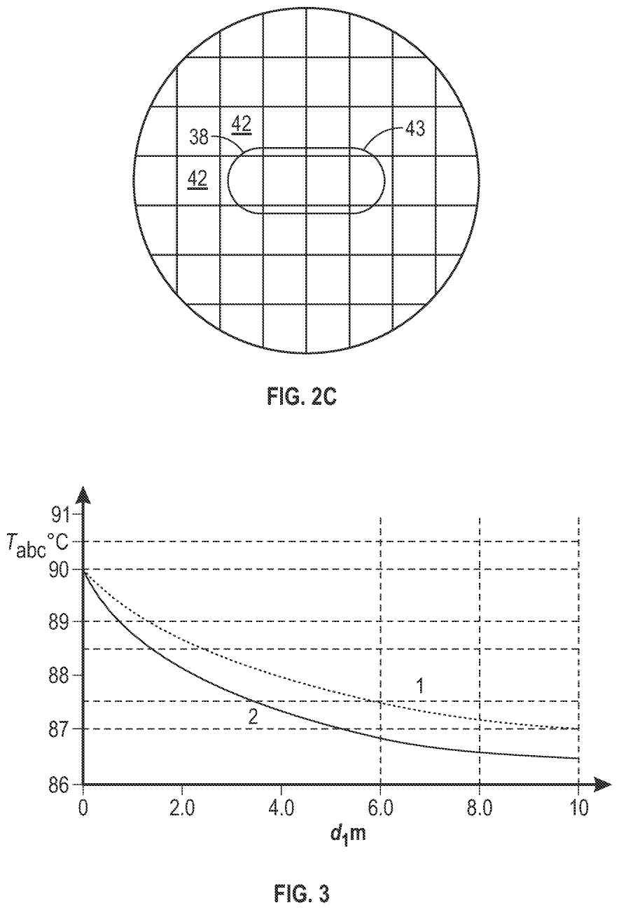

The infrared camera 24 is configured to capture an infrared image 34 (see FIG. 2B) of an exterior surface 36 of the person 14 having a temperature detection region 38. The temperature detection region 38 is depicted in enlarged form in FIG. 2C. The infrared image 34 has pixels 42 (see FIG. 2C—only two of the pixels being numbered for purposes of clarity) indicative of a temperature of the exterior surface 36 of the person 14 within the temperature detection region 38. The temperature detection region 38 is indicative of the person's internal temperature. The exemplary temperature detection region 38 may include a portion of the person's eye 43 that is normally uncovered by the eyelid, such as the canthus, sciera, lacrimal caruncle, or cornea; an exteriorly visible portion of the person's inner ear, such as the auditory canal, or exteriorly visible portion of the person's mouth when open. The infrared camera 24 has circuitry (e.g., communication device) that causes the infrared image 34 to be transmitted over the communication link 18a to the computer system 22. The computer system 22 has a communication device 44 to communicate with one or more of the infrared camera 24, the visible light camera 26, and the range finder 28. The communication device 44 can use any suitable protocol, such as protocols conforming to the requirements of TCP/IP, Wi-Fi, IEEE 802.11a-n or bluetooth, for example. The communication device 44 passes the infrared image 34 to a processor 46. The processor 46 is configured to receive the infrared image 34 from the infrared camera 24 via the communication link 18a. The processor 46 has a non-transitory computer readable medium 48 storing a set of computer executable instructions of a screening process that when executed by the processor 46 cause the processor 46 to identify the temperature detection region 38 within the infrared image 34, read at least one pixel 42 indicative of the temperature of the exterior surface 36 of the person 14, compare the temperature to a temperature threshold, pass a signal to one or more of the devices 161-n to cause the device 16 to perform a predetermined action responsive to the comparison of the temperature to the temperature threshold. The temperature threshold can be set at any desired temperature. When determining whether or not the person 14 has in infection, the temperature threshold can be in the range of normal body temperatures for a human being, i.e., 36.5 C and 37.5 C (97.7 F-99.5 F). In one embodiment, the temperature threshold may be above the normal body temperature for a human being, i.e., within a range from 99.5 F to 100 F. Additionally, the computer system 22 may optionally include a remote server 50 hosting a database 52 for storing information collected and/or associated with the screening process. In some embodiments, the remote server 50 may not be used continuously such that the computer system 22 operates in a stand-alone manner. Data collected by the computer system 22 may be uploaded to the remote server 50 continuously as such data is acquired, in a batch fashion, or not at all.

In some embodiments, the system 10 includes multiple infrared cameras 24 with at least two of the infrared cameras 24 being operated to take an individual temperature reading of the person 14. The temperature readings from the multiple infrared cameras 24 can be combined, e.g., averaged, to obtain a more accurate temperature reading.

The visible light camera 26 is configured to capture a visible light image 54 (see FIG. 2A) of the exterior surface 36 of the person 14 and the identification device 30. The visible light image 54 has pixels 56 (only a few of which are depicted in FIG. 2A for purposes of clarity) indicative of the exterior surface 36 of the person 14, and the identification device 30. The visible light camera 54 has circuitry (e.g., communication device) that causes the visible light image 54 to be transmitted over the communication link 18 to the communication device 44 of the computer system 22. In some embodiments, the communication link 18 can be a bus, such as an address bus, a data bus, or a local bus that provides a data connection between the visible light camera 26 and the processor 46. In these embodiments, the communication device 44 may be optional. The processor 46 of the computer system 22 analyzes the visible light image 54 to locate any feature that may identify the person 14, such as a face 55, eyes 43 or the like. The processor 46 may be programmed with facial recognition software to recognize an identity of the person 14, or the processor 46 may pass the visible light image 54 to a facial recognition computer service, such as facial recognition services. Facial recognition services are available commercially. The processor 46 may also locate the identification device 30 within the visible light image 54. The identification device 30 may have an identification code 58 that can be analyzed by the processor 46. The identification code 58 is encoded with data identifying a particular individual. The identification code 58 can be text, symbol(s), a bar code, a QR code or the like. For example, the identification device 30 can be a business card or a corporate ID card. In one embodiment, the processor 46 reads the identification code 58 to determine a first identity, and analyzes the features of the person to identify a second identity, and then compares the first identity to the second identify. Depending upon the outcome of the comparison, the processor 46 may pass a signal to the device 16 to perform the predetermined action. For example, if the first identity does not match the second identity, then the device 16 may lock a door, forbid access to a space, or output an alert.

In some embodiments, the system 10 can be configured to use video to detect motion thereby activating the system 10 to take a screening without the necessity of a manual operator. This can be accomplished by operating at least one of the infrared camera 24 and the visible light camera 26 between a scan mode and a capture mode. In the scan mode, the sensors within the infrared camera 24 and/or the visible light camera 26 are activated to capture image data in a video mode having one or more frame which are scanned to determine a presence of the person 14. When the person 14 is detected within the one or more frame, the infrared camera 24 and/or the visible light camera 26 are switched to the capture mode for capturing the infrared image 34 and/or the visible light image 54. This permits the system 10 to take temperature readings and verify the identity of the person 14 without the necessity of an operator manually operating the system 10.

As known in the art, atmospheric transmission in the infrared (IR) is an important parameter in radiometric measurements. This is due to the fact that, when the temperature of an object, such as the person 14, is measured, the atmosphere which is between the infrared camera 24 and the person 14 attenuates infrared radiation emitted by the person. Additionally, it has been observed, even in laboratory conditions, that at distance of 1-10 m, the atmospheric absorption, caused mainly by water vapour and carbon dioxide, is noticeable. Shown in FIG. 3 is a graph showing an influece of distance to a temperature measurement for a thermal imaging camera without taking into account correction of the impact of the atmosphere on the measurement (1) being longwavelength, 8-12 micron, and (2) being short wavelength, 2-5 micron. In some embodiments, to be able to accurately determine the temperature of the person 14 when the infrared radiation is spectrally unfiltered, the processor 46 should know a distance d between the infrared camera 24 and the person 14 so that a suitable distance correction can be applied when calculating the values for the pixels 42. In these embodiments, the known distance d can be determined by applying a predetermined mark 60 or device on a floor 62 the known distance d away from the infrared camera 24, or using the range finder 28 to determine a distance from the infrared camera 24 to the exterior surface 36 of the person 30. We can also use the facial recognition to determine if the person is too close or too far. The predetermined mark 60 specifies a location for the person 14 to be (e.g., sit or stand) when the infrared camera 24 is capturing the infrared image 34. The rangefinder 28 may use any suitable technology such as LIDAR, sonar or the like. Or, the processor 46 (or the processor 78 discussed below) may use facial recognition software on the infrared camera 24 to determine range.

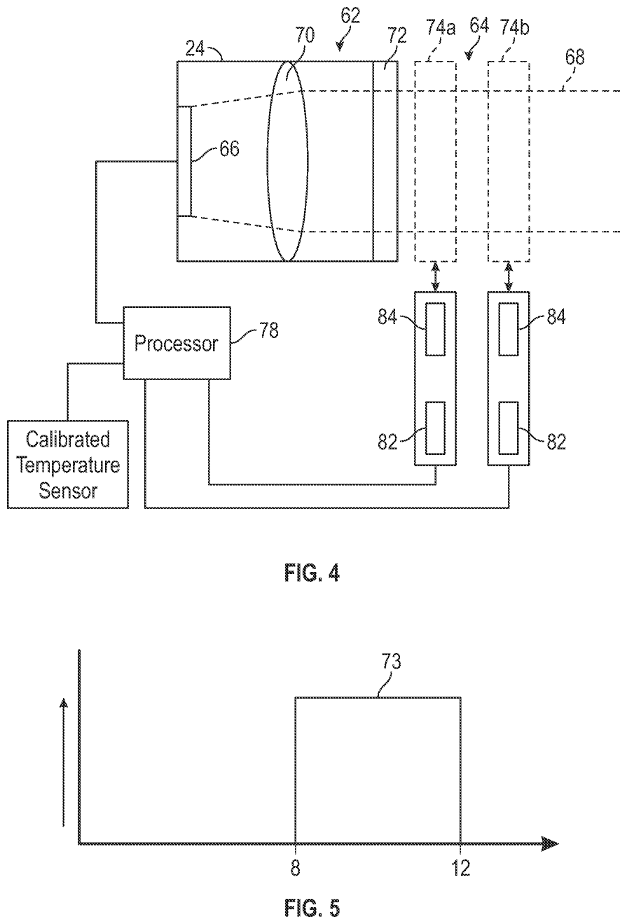

Shown in FIG. 4 is a diagrammatic view of a lens assembly 62 and a calibration assembly 64 of the infrared camera 24. The infrared camera 24 has an array 66 of infrared sensors with one or more of the infrared sensors forming one of the pixels 42. The array 66 has a field of view 68 (which may be in a fan-like pattern. The lens assembly 62 includes a lens 70 and a spectral filter 72. The lens 70 is adjacent to the array 66 for focusing light collected within the field of view 68 onto the array 66. The spectral filter 72 is positioned adjacent to the lens 70 and within the field of view 68. The spectral filter 72 significantly reduces attenuation error caused by H2O and CO2 in the atmosphere. Reducing the attenuation error permits temperature readings at greater distances, and with higher accuracy. The spectral filter 72 is configured to pass radiative energy having a wavelength greater than 8 microns, and in some embodiments only between 8 microns and 12 microns, to the array 66, and block light having a wavelength less than 8 microns. In some embodiments the spectral filter 72 may also block wavelengths greater than 12 microns from reaching the array 66. The spectral filter 72 may be a bandpass filter, or a long-pass filter. FIG. 5 is a graph depicting a passband 73 of the spectral filter 72 when the spectral filter 72 is a bandpass filter.

The calibration assembly 64 can be adapted to calibrate the array 66 of infrared pixels as part of a capture sequence for capturing the infrared image 34. This permits the array 66 to be calibrated within 10 milliseconds of when the infrared image 34 is captured, thereby improving the accuracy and consistency of the temperature reading of the person 14 within the infrared image 34. has a plurality of temperature controlled surfaces 74, such as a first temperature controlled surface 74a having a first temperature and a second temperature controlled surface 74b having a second temperature. The first temperature and the second temperature are different. In one embodiment, the first temperature is below the temperature threshold, and the second temperature is above the temperature threshold. In other embodiments, both the first temperature and the second temperature may be above, or below the temperature threshold. Further, one or the first temperature and the second temperature may be at the temperature threshold. For example, the first temperature controlled surface 74a may have a temperature of 98 degrees Fahrenheit. The second temperature controlled surface 74b may have a temperature 100 degrees Fahrenheit. The first and second temperatures may be within a range of plus or minus 5 degrees, 4 degrees, 3 degrees 2 degrees or 1 degree of 98.6 degrees.

More than two temperature controlled surfaces 74 can be used by the calibration sequence discussed herein. The temperature controlled surfaces 74a and 74b can be thermally isolated portions of a same device (e.g., a rotating device), or be located on two separate devices. In either case, the same device or separate devices having the temperature controlled surfaces 74a and 74b are movable relative to the field of view 68. Preferably, the calibration assembly 64 has an actuator or motor (e.g., stepper motor, rotary solenoid) for moving the same or separate device(s) relative to the field of view 68. The calibration assembly 64 may be adjacent to the array 66 and configured to pass the first temperature controlled surface 74 within the field of view 68 at a first instance of time, and the second temperature controlled surface 74b within the field of view 68 at a second instance of time. The infrared camera 24 includes a processor 78 executing a calibration sequence before obtaining the infrared image 34 of the person 14 that causes the processor 78 to actuate the calibration assembly 64 to place the first temperature controlled surface 74 within the field of view 68 at the first instance of time and activate the array 66 to capture a first image of the first temperature controlled surface 74 to obtain first temperature data T1. Then, the processor 78 actuates the calibration assembly 64 to move the first temperature controlled surface 74 out of the field of view 68, and place the second temperature controlled surface 74b within the field of view 68 at the second instance of time, and activate the array 66 to capture a second image of the second temperature controlled surface 74b. The second image contains temperature data T2. If the calibration assembly 64 includes more than two temperature controlled surfaces, the above-sequence is repeated for each of the temperature controlled surfaces. Then, the processor 78 calibrates pixels within the array 66 using the first image, the second image, etc. as discussed below.

The temperatures of the first and second temperature controlled surfaces 74 may be calibrated with a calibrated temperature sensor 80 known as a pyrometer having a calibration effective time period and a unique serial number. The calibrated temperature sensor 80 is positioned to selectively measure the temperatures of the first and second temperature controlled surfaces 74 immediately (e.g., within 10 milliseconds) prior to the array 66 capturing the first image and the second image. In one embodiment, the calibrated temperature sensor 80 is a calibrated pyrometer receiving radiative energy from the first and second temperature controlled surfaces 74a and 74b. The pyrometer may have a unique identification code, a calibration date, and be NIST traceable. The calibrated pyrometer may be mounted so as to be selectively removable (i.e., not soldered and mounted with a temporary mounting device) and replaceable with a newly calibrated NIST traceable calibrated pyrometer. Each of the temperature controlled surfaces 74 has a temperature controller 82 and a temperature sensor 84. The temperature controller 82 regulates the temperature of the temperature controlled surface 74, and the temperature sensor 84 provides feedback to assist in setting the temperature of the temperature controlled surface 74.

Using a linear assumption, y=mx+b, or Temp=sensitivity×counts+offset, pixels counts from T1 and T2 are used, along with the temperature of the first and second temperature controlled surfaces 74a and 74b (as measured by the calibrated temperature sensor 80) to back-calculate sensitivity and offset. Other types of formulas (e.g., an exponential function) and more temperature data points (T3-Tn) can be used for calculating the sensitity and offset.

Once calibrated, the processor 78 reads the pixels counts in the infrared image 34, and modifies the initial pixel counts with the Temp=sensitivity×counts+offset equation to obtain a calibrated temperature reading for any pixel of interest. This calibrated temperature may have two sources of error, i.e., target emissivity (how emissive vs reflective is the target), inherent measurement error (e.g., plus or minus 0.2 C), and atmospheric absorption. Because human skin has an emissivity of 0.98, this correction is accomplished using conventional calibration techniques. The spectral filter 72 filters out a significant portion of interference caused by atmospheric absorption with respect to H2O and CO2 bands. Once the infrared camera 24 is calibrated, the infrared camera 24 captures the infrared image 34 of the person 14.

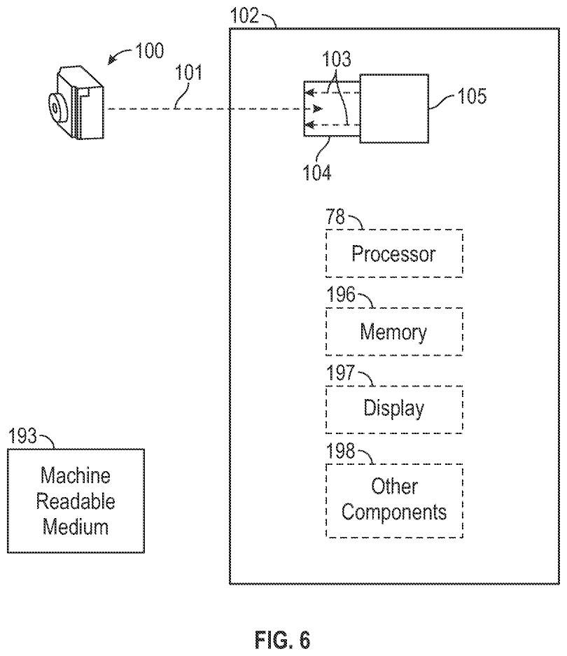

FIG. 6 illustrates the infrared camera 24 having an infrared imaging module 100 and a host device 102. The infrared imaging module 100 may be configured to be implemented separately as a stand-alone unit, or in the host device 102 in accordance with an embodiment of the disclosure. Infrared imaging module 100 may be implemented, for one or more embodiments, with a small form factor and in accordance with wafer level packaging techniques or other packaging techniques.

In one embodiment, host device 102 may be a small, portable unit, such as a mobile telephone, a tablet computing device, a laptop computing device, a personal digital assistant, a visible light camera, a music player, or any other appropriate mobile device (e.g., any type of mobile personal electronic device). In this regard, infrared imaging module 100 may be used to provide infrared imaging features to host device 102. For example, infrared imaging module 100 may be configured to capture, process, and/or otherwise manage infrared images and provide such infrared images to host device 102 for use in any desired fashion (e.g., for further processing, to store in memory, to display, to use by various applications running on host device 102, to export to other devices, or other uses).

As shown in FIG. 6, host device 102 may include a socket 104, a shutter 105, the processor 78, a memory 196, a display 197, and/or other components 198. Socket 104 may be configured to receive infrared imaging module 100 as identified by arrow 101. The first and second temperature controlled surfaces 74a and 74b can be integrated into the shutter 105.

Processor 78 may be implemented as any appropriate processing device (e.g., logic device, microcontroller, processor, application specific integrated circuit (ASIC), or other device) that may be used by host device 102 to execute appropriate instructions, such as software instructions provided in memory 196. Display 197 may be used to display captured and/or processed infrared images and/or other images, data, and information. Other components 198 may be used to implement any features of host device 102 as may be desired for various applications (e.g., clocks, temperature sensors, a visible light camera, or other components). In addition, a machine readable medium 193 may be provided for storing non-transitory instructions for loading into memory 196 and execution by processor 195.

In various embodiments, infrared imaging module 100 and socket 104 may be implemented for mass production to facilitate high volume applications, such as for implementation in mobile telephones or other devices (e.g., requiring small form factors).

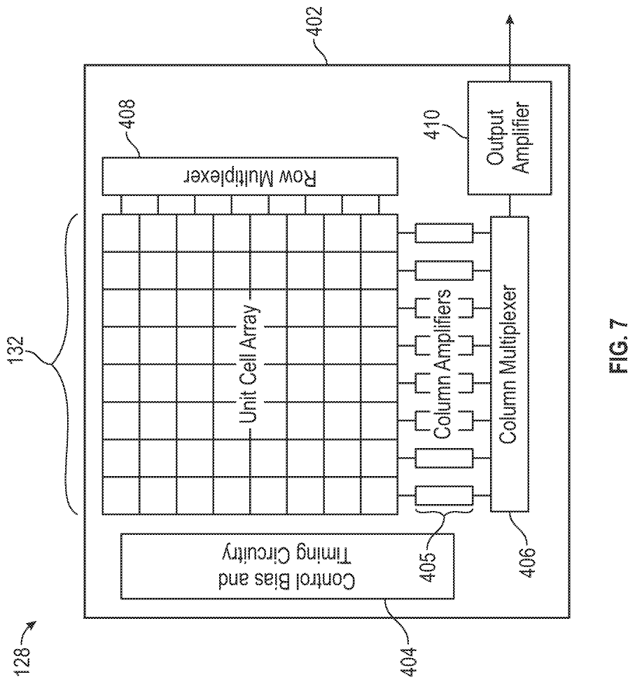

FIG. 7 illustrates a block diagram of infrared sensor assembly 128 of the infrared imaging module 100. The infrared sensor assembly 128 includes an array of infrared sensors 132 in accordance with an embodiment of the disclosure. In the illustrated embodiment, infrared sensors 132 are provided as part of a unit cell array of a read out integrated circuit (ROIC) 402. ROIC 402 includes bias generation and timing control circuitry 404, column amplifiers 405, a column multiplexer 406, a row multiplexer 408, and an output amplifier 410. Image frames (e.g., thermal images) captured by infrared sensors 132 may be provided by output amplifier 410 to processing module 160, processor 78, and/or any other appropriate components to perform various processing techniques described herein. Although an 8 by 8 array is shown in FIG. 7, any desired array configuration may be used in other embodiments. Further descriptions of ROICs and infrared sensors (e.g., microbolometer circuits) may be found in U.S. Pat. No. 6,028,309 issued Feb. 22, 2000, which is incorporated herein by reference in its entirety. Infrared sensors 132 may be implemented, for example, as microbolometers or other types of thermal imaging infrared sensors arranged in any desired array pattern to provide a plurality of pixels. In one embodiment, infrared sensors 132 may be implemented as vanadium oxide (VOx) detectors with a 17 μm pixel pitch. In various embodiments, arrays of approximately 32 by 32 infrared sensors 132, approximately 64 by 64 infrared sensors 132, approximately 80 by 64 infrared sensors 132, or other array sizes may be used.

Infrared sensors 132 may be configured to detect infrared radiation (e.g., infrared energy) from a target scene including the person 14 and the identification device 30, for example, mid wave infrared wave bands (MWIR), long wave infrared wave bands (LWIR), and/or other thermal imaging bands as may be desired in particular implementations. In one embodiment, the infrared sensors 132 are configured to detect infrared radiation in the wavelength range of 8-12 microns as discussed above. In one embodiment, infrared sensor assembly 128 may be provided in accordance with wafer level packaging techniques.

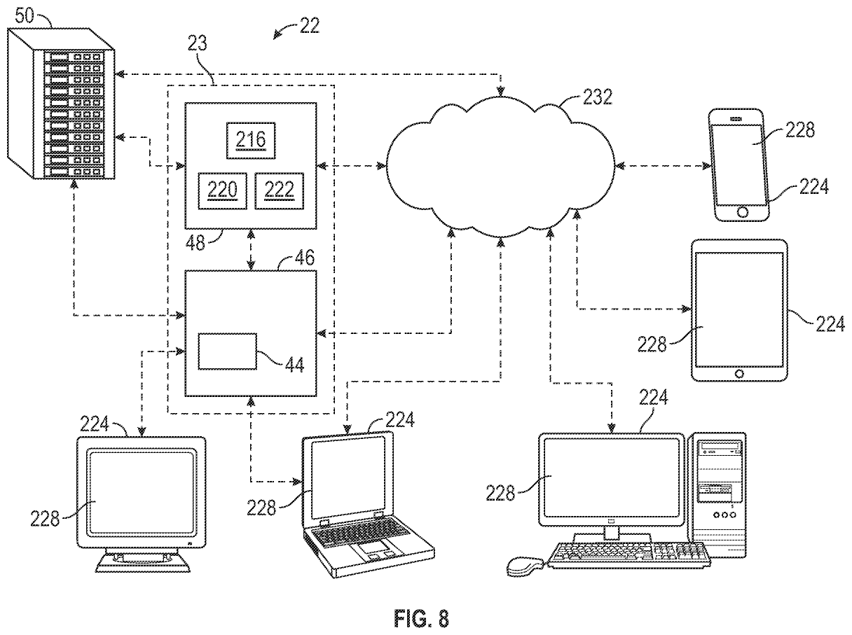

Referring now to FIG. 8, shown therein is a block diagram of the computer system 22 in accordance with the present disclosure designed to carry out the contactless screening procedure. The contactless screening procedure. The computer system 22 may comprise one or more local computer 23 having the processor 46, one or more non-transitory computer-readable storage medium 48, and one or more communication device 44. The one or more non-transitory computer-readable storage medium 48 may store one or more database 216, program logic 220, and computer executable instructions 222. The computer system 22 may bi-directionally communicate with a plurality of user devices 224, which may or may not have one or more screens 228, and/or may communicate via a network 232. The processor 46 or multiple processors 46 may or may not necessarily be located in a single physical location.

In one embodiment, the non-transitory computer-readable medium 48 stores program logic, for example, a set of instructions capable of being executed by the one or more processor 46, that when executed by the one or more processor 46 causes the one or more processor 46 to carry out the screening procedures discussed above.

In one embodiment, the network 232 is the Internet and the user devices 224 interface with the processor 46 via the communication device 44 and a series of web pages. It should be noted, however, that the network 232 may be almost any type of network and may be implemented as the World Wide Web (or Internet), a local area network (LAN), a wide area network (WAN), a metropolitan network, a wireless network, a cellular network, a Global System for Mobile Communications (GSM) network, a code division multiple access (CDMA) network, a 3G network, a 4G network, a 5G network, a satellite network, a radio network, an optical network, a cable network, a public switched telephone network, an Ethernet network, combinations thereof, and/or the like. It is conceivable that in the near future, embodiments of the present disclosure may use more advanced networking topologies.

In one embodiment, the computer system 22 comprises the server system 50 having one or more servers in a configuration suitable to provide a commercial computer-based business system such as a commercial web-site and/or data center. The server system 50 may be connected to the network 232 and adapted to receive data from multiple local computers 23. Once the data is uploaded to the server system 50 from the local computers 23, the data can be used for a variety of tasks, such as logistics for ordering/shipping supplies to regions that have an unusually high rate of infection, marketing, or monitoring by the federal government. Each set of uploaded data can be identified with a unique code. Each set of uploaded data can include the infrared image 34, the visible light image 54, the unique identifier for the temperature controlled sensor, a determined identity of the person 14, a temperature of the person 14, a time/date stamp of the screening, a location of the screening (e.g., address, lat/long or other geo-identifier).

Although the present system 10 has been described by way of example as determining a temperature and an identity of the person 14, it should be understood that the techniques described herein apply equally to determining a temperature and/or characteristic of one or more subjects. The subject can be a living organism, such as a mammal, or insect. Or, the subject can be a non-living article, such as an item being manufactured. The infrared camera 24 described herein can be used to remotely sense and determine a temperature of the person 14, a living subject, or non-living subject.

From the above description, it is clear that the inventive concepts disclosed and claimed herein are well adapted to carry out the objects and to attain the advantages mentioned herein, as well as those inherent in the invention. While exemplary embodiments of the inventive concepts have been described for purposes of this disclosure, it will be understood that numerous changes may be made which will readily suggest themselves to those skilled in the art and which are accomplished within the spirit of the inventive concepts disclosed and claimed herein.

What is claimed is:

1. A system, comprising:
a device configured to perform an action;
a communication link;
an infrared camera configured to capture an infrared image of an exterior surface of a person having a temperature detection region, the infrared image having a pixel indicative of a temperature of the exterior surface of the person within the temperature detection region, the temperature detection region being indicative of the person's internal temperature, the infrared camera having circuitry that causes the infrared image to be transmitted over the communication link;
a processor configured to receive the infrared image from the infrared camera via the communication link, the processor having a non-transitory computer readable medium storing a set of computer executable instructions that when executed by the processor cause the processor to:
identify the temperature detection region within the infrared image;
read the pixel indicative of the temperature of the exterior surface of the person;
compare the temperature to a temperature threshold; and
pass a signal to the device to cause the device to perform the action responsive to the temperature being above a temperature threshold.

2. A method, comprising:
a. capturing, by an infrared camera, a first image of a first temperature controlled surface having a first known temperature below a temperature threshold, the infrared camera having an array of infrared sensors, the first image having first pixels, the first pixels having first data indicative of a plurality of first temperatures;
b. capturing, by the infrared camera, a second image of a second temperature controlled surface having a second known temperature above the temperature threshold, the second image having second pixels, the second pixels having second data indicative of a plurality of second temperatures;
c. calibrating a plurality of the pixels in the array of infrared sensors with the first data and the second data.

3. The method of claim 2, further comprising:
d. capturing by the infrared camera a plurality of third images, wherein steps a., b., and c. are performed prior to step d. for each third image.

4. An infrared camera, comprising:
an array of infrared sensors forming pixels, and having a field of view;
a lens adjacent to the array of infrared sensors for focusing light collected within the field of view onto the array of infrared sensors;
a calibration assembly having a first temperature controlled surface and a second temperature controlled surface, the calibration assembly adjacent to the array of infrared sensors and configured to pass the first temperature controlled surface within the field of view at a first instance of time, and the second temperature controlled surface within the field of view at a second instance of time;
a processor executing a calibration sequence that causes the processor to actuate the calibration assembly to place the first temperature controlled surface within the field of view at the first instance of time and activate the array of infrared sensors to capture a first image of the first temperature controlled surface, actuate the calibration assembly to place the second temperature controlled surface within the field of view at the second instance of time and activate the array of infrared sensors to capture a second image of the second temperature controlled surface, and calibrate pixels using the first image and the second image.

5. An infrared camera, comprising:
an array of infrared sensors having pixels, and a field of view;
a lens adjacent to the array of infrared sensors for focusing light collected within the field of view onto the array of infrared sensors;
a band pass filter positioned adjacent to the lens and within the field of view, the band pass filter configured to pass light having a wavelength between 8 microns and 12 microns to the array of infrared sensors, and block light having a wavelength less than 8 microns, and greater than 12 microns.
